(19) United States
(12) Patent Application Publication
(10) Pub. No.: US 2010/0258060 A1
(43) Pub. Date: Oct. 14, 2010

(54) MODULAR BALL TRACK CAT TOY

(76) Inventors: Randy R. Wilson, Rio Linda, CA (US); Fred A. Cox, Sutter, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 12/747,120

(22) PCT Filed: Dec. 9, 2008
(86) PCT No.: PCT/US08/13526

§ 371 Date: Jun. 9, 2010

Related U.S. Application Data
(60) Provisional application No. 60/996,883, filed on Dec. 10, 2007.

(51) Int. Cl. A01K 15/02; A01K 29/00

(52) U.S. Cl. 119/707

(57) ABSTRACT

The modular ball track cat toy (10) includes a ball (15) disposed in a track that is expandable, i.e., modular. The modular track includes sections of track that may have different sizes and shapes. The track sections (20, 25) may be coupled by a universal connector (17). The various track sizes and shapes allow a user to set up the track in various configurations for continuously new cat play activities. Each track section (20, 25) is a tube having a top opening dimensioned so that the ball (15) can freely roll inside the tube but cannot escape the tube through the top opening. The universal connector (17) and tube sections (20, 25) have interlocking members (19, 52, 18, 50) that constrain rotational and axial movement of the tube sections (20, 25), thereby preventing the pet from dismantling or twisting the toy (10) during play.

### FIELD OF THE INVENTION

The present invention relates to toys for animals, and more particularly to a modular ball track cat toy including a ball and a modular or expandable track.

### DESCRIPTION OF THE RELATED ART

A variety of cat amusement devices featuring rolling balls have been developed and placed on the market. However, until now, a tamper-proof, effective track system for guiding a rolling ball has not been developed for cats to play with. While open, straight and curved track sections that may be placed end-to-end to form a track system have been developed, the ball can escape from such open systems when the cat is toying with the ball.

Thus, a modular ball track cat toy solving the aforementioned problems is desired.

### DISCLOSURE OF INVENTION

The modular ball track cat toy includes a ball disposed in a track that is expandable, i.e., modular. The modular track includes sections of track that may have different sizes and shapes. The track sections may be coupled by a universal connector. The various track sizes and shapes allow a user to lay out customized tracks for continuously new cat play activities. Each track section is a tube having a top opening. The top opening is dimensioned so that the ball can freely roll inside the tube but cannot escape the tube through the top opening. Thus, the cat has access to the ball inside the tube but cannot extract the ball from the tube. The universal connector and tube sections have interlocking members that constrain rotational and axial movement of the tube sections, thereby preventing the pet from dismantling or twisting the toy during play.

These and other features of the present invention will become readily apparent upon further review of the following specification and drawings.

### BRIEF DESCRIPTION OF DRAWINGS

FIG. 1 is an environmental, perspective view of a modular ball track cat toy according to the present invention.

FIG. 2 is an exploded, perspective view of the modular ball track cat toy according to the present invention.

FIG. 3 is a perspective view of a curved track component of the modular ball track cat toy according to the present invention.

FIG. 4 is a perspective view of a straight track component of the modular ball track cat toy according to the present invention.

FIG. 5 is an exploded perspective view of a coupling joint in the modular ball track cat toy according to the present invention, with parts broken away and partially in section to show details thereof.

Similar reference characters denote corresponding features consistently throughout the attached drawings.

### BEST MODES FOR CARRYING OUT THE INVENTION

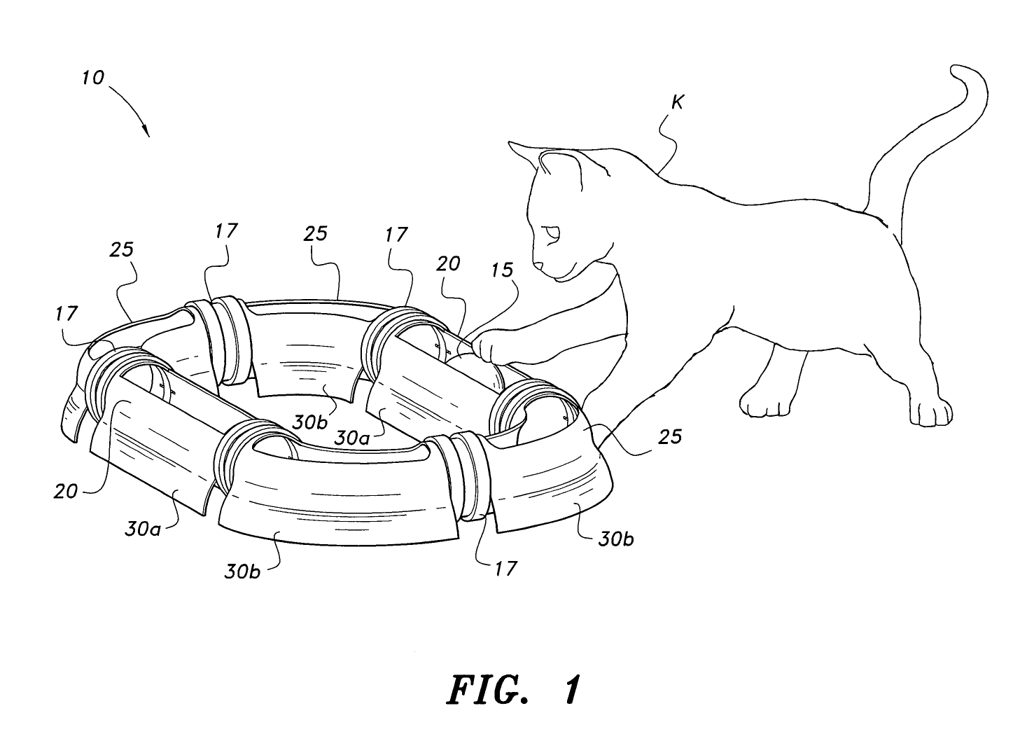

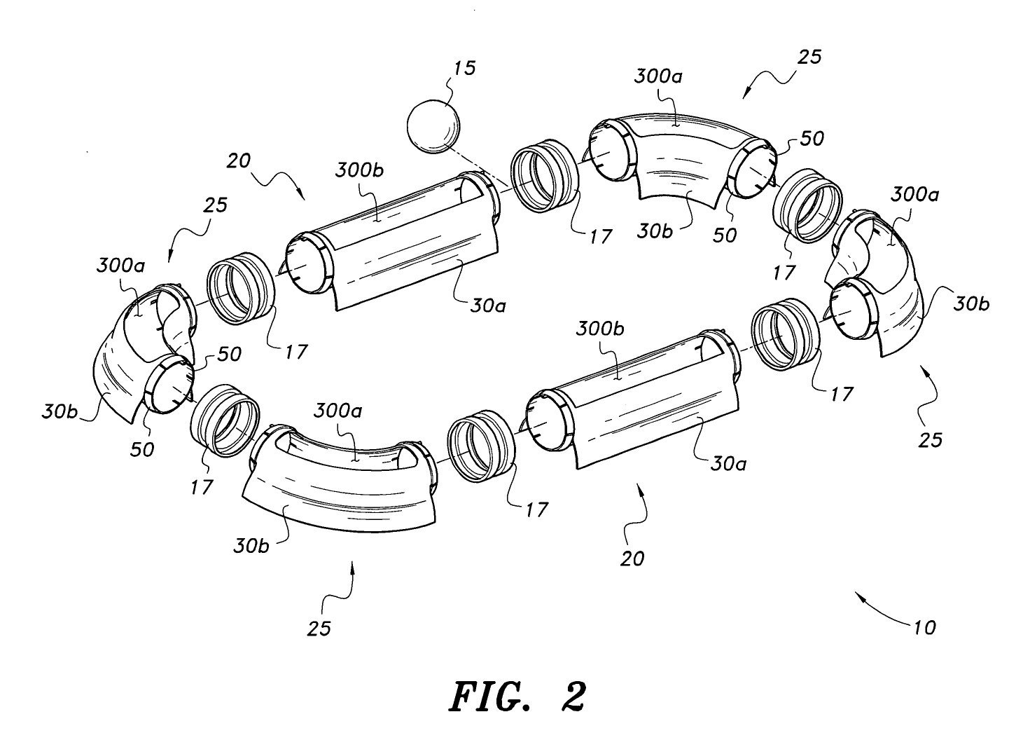

As shown in FIGS. 1-2, the present invention relates to a modular ball track cat toy having a modular track 10 that holds ball 15. The modular track 10 comprises sections of track that may have different sizes and shapes. For example, a straight section 20 may be connected to another straight section 20 or may be connected to a curved section 25. By varying the interconnections of sections, a wide variety of ball paths may be formed by the user for amusement of cat K.

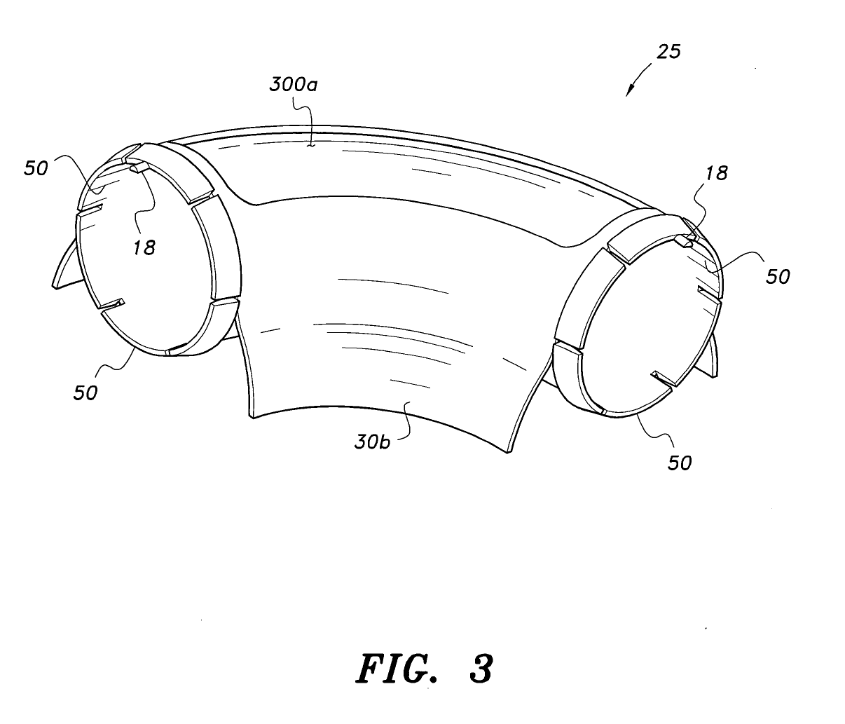

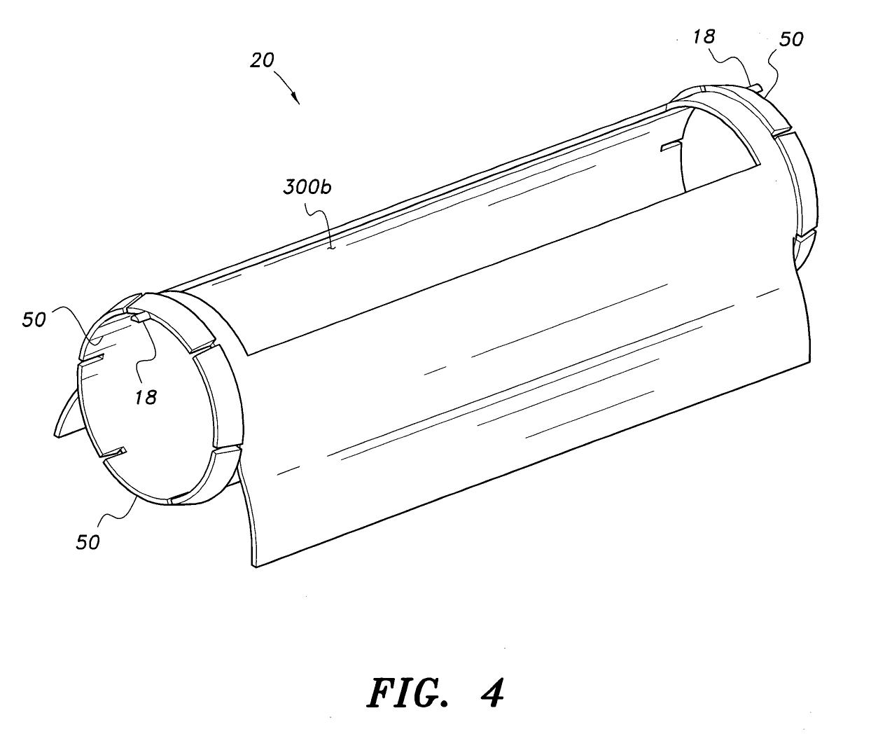

The various track sizes and shapes allow a user to set up the track in a variety of layouts for continuously new cat play activities. As shown in FIGS. 1, 3, and 4, each track section 20, 25 is a tube having a top opening, such as substantially linear top opening 300b or substantially arcuate top opening 300a. Moreover, the straight tube 20 is supported by substantially elongate, bilaterally extending support members 30a, while curved tube 25 is supported by substantially arcuate bilaterally extending support members 30b. The tube top openings are dimensioned so that the ball 15 can freely roll inside the tube, but cannot escape the tube through either type of top opening. Thus, the cat has access to the ball 15 inside the toy 10 but cannot extract the ball 15 from tubular section openings 300a, 300b of the toy track 10.

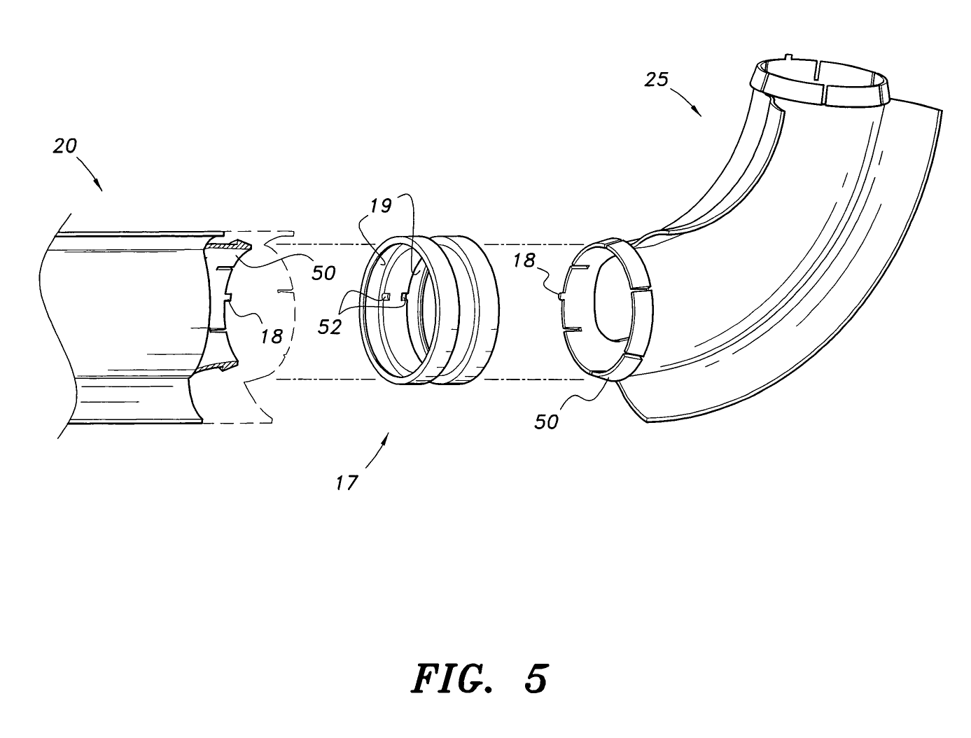

As shown in FIG. 5, universal connector 17 interconnects linear section 20 with another linear section 20 or with an arcuate section 25. The universal connector 17 has dual annular channels 19 that engage circumferential tabs 50 at ends of sections 20, 25 to constrain axial movement of the interconnected sections. Additionally, the universal connector 17 has dual-sided receiving apertures 52 that receive alignment pins 18 of the interconnected sections to constrain twisting or rotational misalignment between the interconnected sections. The axial and rotational interlock of interconnected sections to universal connector 17 prevents the pet from dismantling or twisting the track 10 during play.

It is to be understood that the present invention is not limited to the embodiments described above, but encompasses any and all embodiments within the scope of the following claims.

We claim:

1. A modular ball track cat toy, comprising:
a plurality of tubular track sections, each of the track sections having an elongated top opening defined therein having a width;
a removable connector coupling any two of the track sections, the, removable connector having fittings attachable to either end of the track sections, the connector constraining rotational and axial movement of the interconnected track sections; and
a ball rollable in the track sections, the ball having a diameter slightly greater than the width of the top opening so that the ball is irremovable from the track through the top openings;
whereby, a cat may reach through the top openings to roll the ball, the ball being irremovable through the top openings.

2. The modular ball track cat toy according to claim 1, wherein the plurality of tubular track sections comprises at least one straight section.

3. The modular ball track cat toy according to claim 2, wherein the at least one straight section further comprises substantially elongate bilaterally extending support members.

4. The modular ball track cat toy according to claim 1, wherein the plurality of tubular track sections comprises at least one curved section.

5. The modular ball track cat toy according to claim 4, wherein the at least one curved section further comprises substantially arcuate bilaterally extending support members.

6. The modular ball track cat toy according to claim 1, wherein the removable connector has dual annular channels and each of the track sections has circumferential tabs extending therefrom, the tabs engaging the channels to lock the tubular sections together.

7. The modular ball track cat toy according to claim 6, wherein the removable connector has at least one alignment aperture defined therein, each of the sections having at least one alignment pin extending from one of the tabs, the alignment pin engaging the alignment aperture in order to constrain twisting and rotational misalignment of the track sections when the track sections are joined by the removable connector.
